(19) United States
(12) Patent Application Publication
(10) Pub. No.: US 2003/0172535 A1
(43) Pub. Date: Sep. 18, 2003

(54) Lockset guide

(76) Inventor: Robert Lovell Grizzle, Lula, GA (US)

Correspondence Address: Robert L. Grizzle, 6400 Narramore Way, Lula, GA, 30554, US

(21) Appl. No.: 10/097,456

(22) Filed: Mar. 15, 2002

(51) Int. Cl. E06B 3/00

(52) U.S. Cl. 33/194

(57) ABSTRACT

An apparatus for guiding the placement of the holes needed for the installation of door knobs and or lock sets in new or existing doors. The apparatus is attached to the door to be sawed and or drilled temporally, where the holes needed can then be sawed and or drilled at the proper locations to assure proper operation of door knobs and or lock sets.

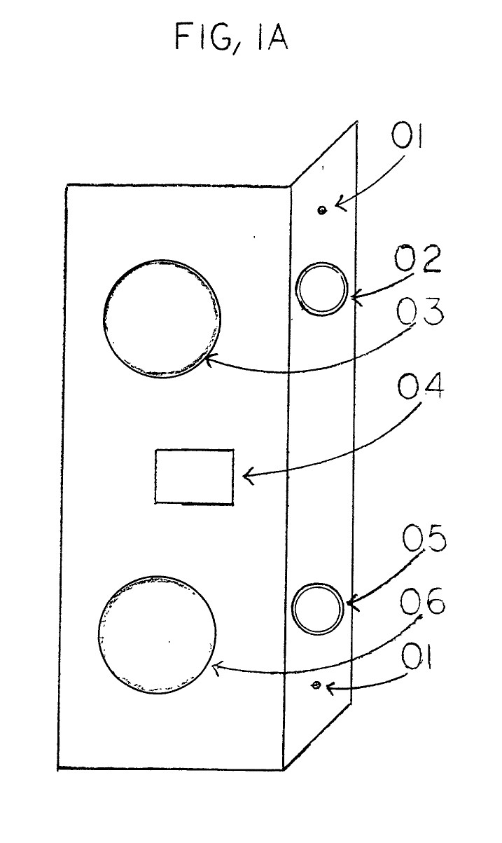

### BACKGROUND OF THE INVENTION

Home building and home improvement projects often have the need to install new doors and or the need to modify existing doors to accommodate modern door knobs and lock sets, by drilling holes in the face and side of the door.

The conventional method used to drill these holes is to manually measure out each starting point to align the holes to intersect at the proper location to assure the proper operation of the door knob and or lock set.

### SUMMARY OF THE INVENTION

The present invention relates to the guiding of the holes that are to be drilled for the installation of door knobs and or lock sets. After guide is temporally attached to door, holes can then be drilled in door at proper locations to assure proper installation and operation of door knobs and or lock sets.

The object of the present invention is to provide a simple method and apparatus to drill holes in doors, for door knobs and or lock sets in new or existing doors. The present invention seeks to accomplish this by providing an apparatus to guide the drilling of holes needed at the proper locations on face and side of doors, wherein the apparatus is attached to the door, where the holes needed to install door knobs and or lock sets are guided to the proper locations for sawing or drilling.

1. An apparatus for guiding and placement of the holes needed for the installation of door knobs and or lock sets in new or existing doors.
